(19) United States
(12) Patent Application Publication
(10) Pub. No.: US 2017/0069068 A1
(43) Pub. Date: Mar. 9, 2017

(54) WIDE DYNAMIC RANGE IMAGING METHOD

(71) Applicant: REALTEK SEMICONDUCTOR CORP., HSINCHU (CN)

(72) Inventors: WEI-TE CHANG, TAOYUAN CITY (TW); SHIH-TSE CHEN, HSINCHU COUNTY (TW)

(21) Appl. No.: 15/229,144

(22) Filed: Aug. 5, 2016

(30) Foreign Application Priority Data
Sep. 9, 2015 (TW) 104129834

(51) Int. Cl. G06T 5/00; G06T 7/00

(52) U.S. Cl. CPC G06T 5/009; G06T 7/0081; G06T 2207/20144; G06T 2207/10004; G06T 2207/20208; G06T 2207/10144; G06T 2207/10024; G06T 2207/20148

(57) ABSTRACT

A wide dynamic range imaging method provided by an exemplary embodiment of the present disclosure has steps as follows. According to a first difference value between a light-part average luminance value and a dark-part average luminance value of an image, a first enhancing value is obtained. According to the dark-part average luminance value and a dark-part pixel number, the first enhancing value is adjusted to generate a second enhancing value. A light-part weighted average value in first regions of the image and a dark-part weighted average value in second regions of the image are calculated, a second difference value between the dark-part weighted average value and the light-part weighted average value is calculated, and the second enhancing value is adjusted to generate a third enhancing value according to the second difference value. The third enhancing value is used to selectively adjust pixels of the image.

### BACKGROUND

1. Technical Field

The disclosed embodiments relate generally to an imaging method, and more particularly, to a wide dynamic range imaging method.

2. Description of Related Art

Regarding the image with high contrast grounds (such as, the extremely dark foreground and the extremely light background), if the image capturing apparatus increases its exposure rate, the moderate lightness will be given to the foreground, but the background will be over-exposed. By contrast, if the image capturing apparatus decreases its exposure rate, the moderate lightness will be given to the background, but the foreground will be too dark.

The high dynamic range imaging method can obtain two images for one scene with different exposure rates, and synthesizes the two obtained images, such that the foreground and the background within the scene have moderate lightness. However, the high dynamic range imaging method has a complex algorithm, and the image capturing apparatus requires an excellent light sensing component for exposing selectively with different exposure rates. Even the frame rate or the processing speed of the image capturing apparatus must be further enhanced to successfully perform the high dynamic range imaging method.

### SUMMARY

An exemplary embodiment of the present disclosure provides a wide dynamic rage imaging method which comprises the following steps. According to a first difference value between a light-part average luminance value and a dark-part average luminance value of an image, a first enhancing value is obtained. According to the dark-part average luminance value and a dark-part pixel number, the first enhancing value is adjusted to generate a second enhancing value. A light-part weighted average value in first regions of the image and a dark-part weighted average value in second regions of the image are calculated, a second difference value between the dark-part weighted average value and the light-part weighted average value is calculated, and the second enhancing value is adjusted to generate a third enhancing value according to the second difference value. The third enhancing value is used to selectively adjust the pixels of the image.

To sum up, the wide dynamic range imaging method provided by the exemplary embodiment of the present disclosure can increase the fineness of the whole image, and simultaneously make details in the dark region and the light region be viewed apparently.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a flow chart of a wide dynamic range imaging method according to one exemplary embodiment of the present disclosure.

FIG. 2A through FIG. 2C are histograms of three different images according to exemplary embodiments of the present disclosure.

FIG. 3 is a schematic diagram showing a darkness weighting process according to one exemplary embodiment of the present disclosure.

FIG. 4 is a schematic diagram showing an image divided into first regions and second regions according to one exemplary embodiment of the present disclosure.

FIG. 5 is a schematic diagram showing a wide dynamic range gain adjusting process, an exposure gain adjusting process, or a gamma gain adjusting process selectively performed on each pixel of the image according to one exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

An exemplary embodiment of the present disclosure provides a wide dynamic range imaging method, and the wide dynamic rage imaging method firstly obtains a difference value between a light-part average luminance value and a dark-part average luminance value of an image (i.e. subtract the dark-part average luminance value from the light-part average luminance value to obtain the difference value) via a histogram of the image, and then obtains the first enhancing value according to the difference value. Then considering the condition that the image has the large difference value but does not have the high contrast grounds, the wide dynamic range imaging method performs a darkness weighting process to adjust the first enhancing value, and then generates the second enhancing value, accordingly. Next, a central luminance weighting process is performed to adjust the second enhancing value, and then the third enhancing value is generated, accordingly. Next, the wide dynamic range imaging method performs a wide dynamic range gain adjusting process, an exposure gain adjusting process, or a gamma gain adjusting process on each of the pixels of the image according to the third enhancing value, and then outputs an adjusted image.

In the exemplary embodiment of the present disclosure, the darkness weighting process adjusts the first enhancing value according to a dark-part pixel number and the dark-part average luminance value, so as to generate the second enhancing value. The central luminance weighting process divides the image into first regions (corresponding to a preset background region) and second regions (corresponding to a preset foreground region), calculates the light-part weighted average value according to the luminance values and weighting values of the first regions, calculates the dark-part weighted average value according to the luminance values and weighting values of the second regions, and then adjusts the second enhancing value according to the dark-part weighted average value and the light-part weighted average value, so as to generate the third enhancing value.

In addition, in the exemplary embodiment of the present disclosure, the third enhancing value is used to determine whether the pixels which have luminance values less than a specific threshold value should be adjusted, and according to at least one of a selected scene mode, a hardware specification, and the third enhancing value, the wide dynamic range gain adjusting process is performed on the pixels which have luminance values within a first luminance range, the exposure gain adjusting process is performed on the pixels which have luminance values within a second luminance range, and the Gamma gain adjusting process is performed on the pixels which have luminance values within a third luminance range. The third enhancing value can be a percentage, such as 90%, the first luminance range is the range between the 90% and 30% of the maximum luminance value (depending on the bit number for presenting the luminance value), the second luminance range is the range between the 30% and 20% of the maximum luminance value, and the third luminance range is the range between the 10% and 20% of the maximum luminance value.

The wide dynamic range imaging method can be applied in a digital camera, a camera in a smart phone, a pad, or a monitoring system, without modifying the design of the light sensing component. The wide dynamic range imaging method can efficiently increase the luminance of the low luminance part within the scene of the image and decrease the luminance of the high luminance part within the scene of the image, such that the visibility of the image is enhanced, and the edge effect of the image is avoided. Next, details of the wide dynamic range imaging method are illustrated as follows.

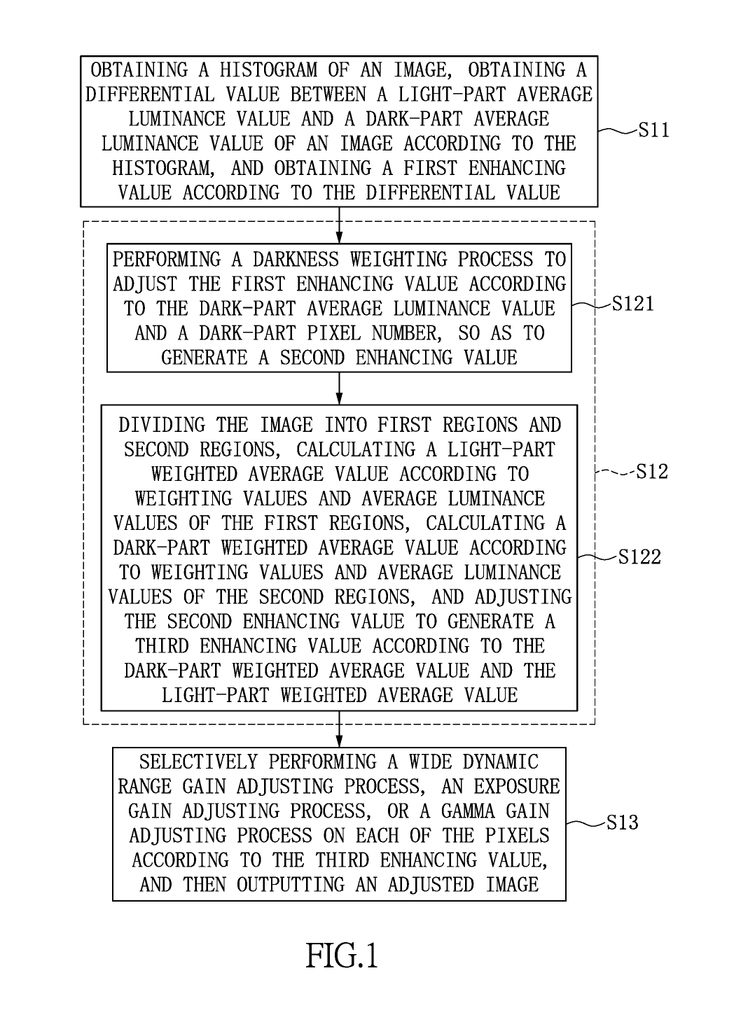

Referring to FIG. 1, FIG. 1 is a flow chart of a wide dynamic range imaging method according to one exemplary embodiment of the present disclosure. The wide dynamic range imaging method can be executed in the any kind of image capturing apparatus. To enhance the light-part and the dark-part within the scene of the image to increase the quality of the image, merely one image should be captured. The wide dynamic range imaging method comprises steps step S11 through S13 stated as follows.

Firstly, at step S11, according to a difference value between the light-part average luminance value and the dark-part average luminance value of the image, a first enhancing value is obtained. Specifically, the wide dynamic range imaging method performs a luminance statistics process on the captured image to obtain the histogram of the image. Next, the wide dynamic range imaging method performs an average calculation on the luminance values lower than a specific threshold value TH to obtain a dark-part average luminance value m1, and performs the average calculation on the luminance values higher than or equal to a specific threshold value TH to obtain light-part average luminance value m2 Next, the wide dynamic range imaging method calculates the difference value between the light-part average luminance value m2 and the dark-part average luminance value m1, i.e. the difference value is equal to m1−m2, and then by using a specific mapping relation, the wide dynamic range imaging method obtains the first enhancing value according to the difference value, wherein the first enhancing value can be a percentage.

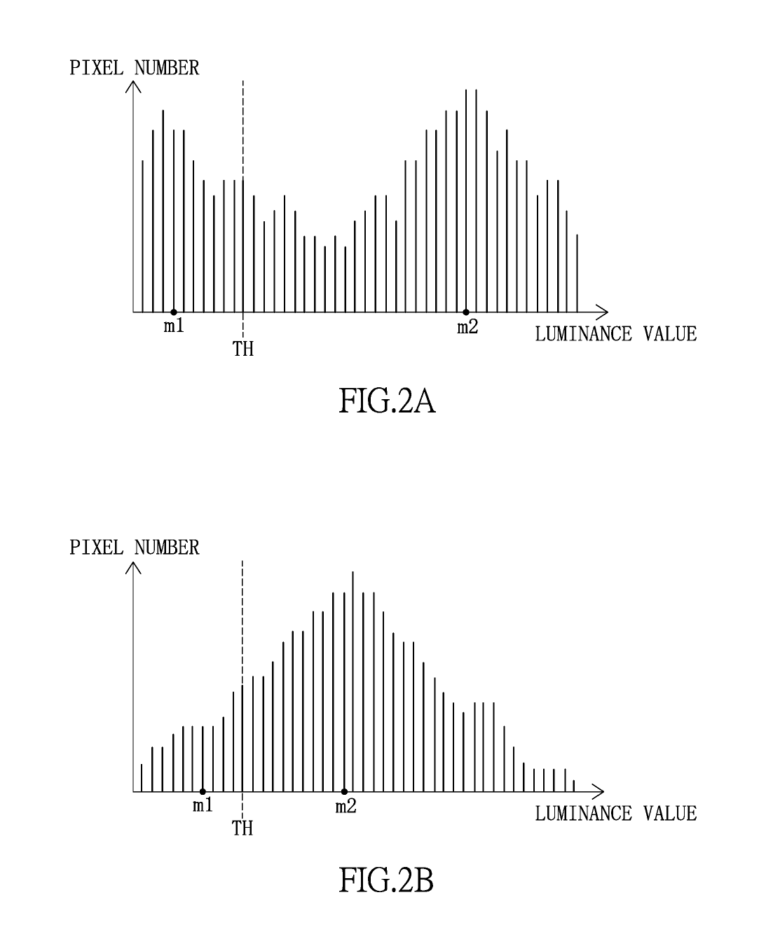

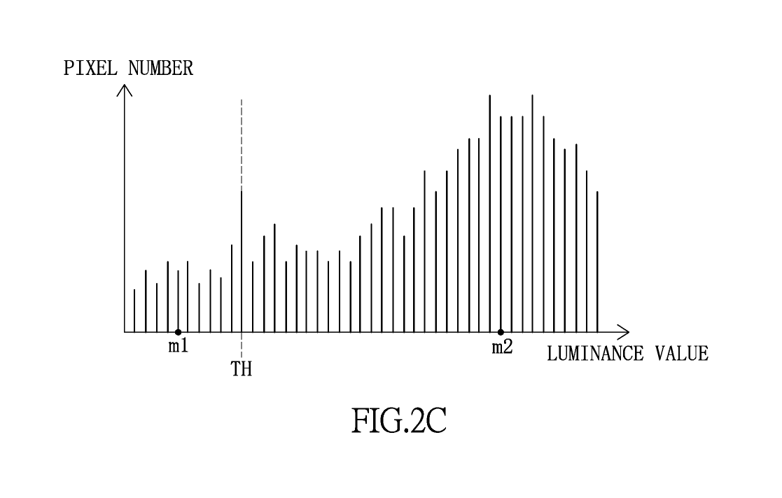

Referring to FIG. 1, FIG. 2A, and FIG. 2B, FIG. 2A and FIG. 2B are histograms of two different images according to exemplary embodiments of the present disclosure. The histogram of the image obtained at step S11 may be one of the histograms of FIG. 2A or FIG. 2B. In the exemplary embodiments, the histogram of FIG. 2A corresponds to the image with high contrast grounds (the foreground within the scene is dark and the background within the scene is light), and the histogram of FIG. 2B does not correspond to the image with high contrast grounds. Observing the histograms of FIG. 2A and FIG. 2B, it can be known that the difference value calculated by step S11 of FIG. 2B is lower than that of FIG. 2A, and thus, the difference value calculated by step S11 can be used to indicate the contrast level of the high contrast grounds, wherein the higher the contrast level of the high contrast grounds is, the larger the first enhancing value is.

Next, still referring to FIG. 1, at step S12, the wide dynamic range imaging method firstly performs the darkness weighting process (such as step S121), then adjusts the first enhancing value to generate the second enhancing value, and next performs the central luminance weighting process (such as step S122) to adjust the second enhancing value to generate the third enhancing value.

Referring to FIG. 1, FIG. 2A, and FIG. 2C, FIG. 2C is a histogram of another one image according to one exemplary embodiment of the present disclosure. The histogram in FIG. 2C does not correspond to the image with the high contrast grounds, and however, the difference value of FIG. 2C is little deviated from that of FIG. 2A. Thus, considering the condition that the image has the large difference value but does not have the high contrast grounds, the wide dynamic range imaging method further performs weighting processes on the first enhancing value at step S12, so as to avoid much strongly adjusting the image which has the large difference value but does not have the high contrast grounds.

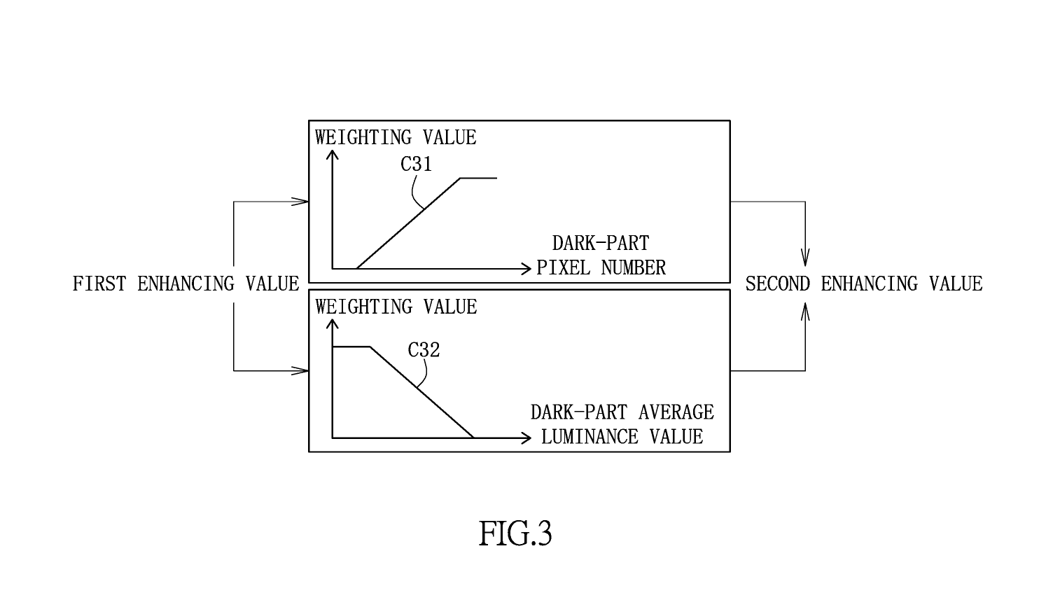

Still referring to FIG. 1, step S12 comprises steps S121 and S122, and details of them are illustrated as follows. At step S121, the wide dynamic range imaging method adjusts the first enhancing value to generate the second enhancing value according to the dark-part pixel number and the dark-part average luminance value. Further referring to FIG. 3, FIG. 3 is a schematic diagram showing a darkness weighting process according to one exemplary embodiment of the present disclosure. At step S121, by using the mapping curve C31 of the dark-part pixel number and the weighting values and the mapping curve C32 of the dark-part average luminance value and the weighting values, the first enhancing value is adjusted to be the second enhancing value. Generally speaking, the larger the dark-part pixel number is, or the less the dark-part average luminance value is, the stronger the adjusting is. For example, the first enhancing value is 90%. However, since the dark-part pixel number does not reach a first specific value, the first enhancing value is multiplied with a first specific ratio (such as 0.8), and since the dark-part average luminance value is larger than a second specific value, the first enhancing value is further multiplied with a second specific ratio (such as 0.9). Therefore, the second enhancing value being 64.8% (i.e. 90%·0.8.·0.9=64.8%) is obtained.

Next, referring to FIG. 1 again, at step S122, the wide dynamic range imaging method divides the image into first regions and second regions, wherein each of the first regions has a corresponding weighting value, and each of the second regions has a corresponding weighting value. The first regions and the second regions respectively correspond to the background regions and the foreground regions of the image. Next, the wide dynamic range imaging method calculates the light-part weighted average value according to the weighting values and the average luminance values of the first regions, calculates the dark-part weighted average value according to the weighting values and the average luminance values of the second regions, and then adjusts the second enhancing value to generate the third enhancing value according to the dark-part weighted average value and the light-part weighted average value. Moreover, the division of the first regions and the second regions associated with the image and the weighting values are determined according to a selection of a scene mode.

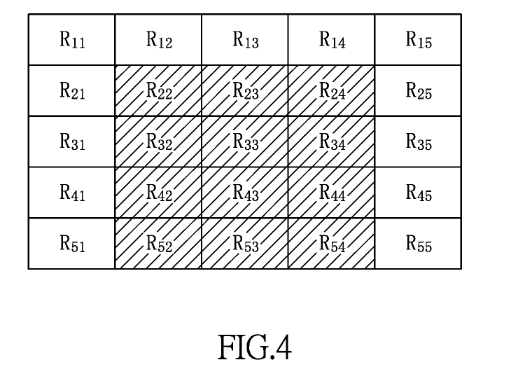

Referring to both of FIG. 4 and FIG. 1, FIG. 4 is a schematic diagram showing an image divided into first regions and second regions according to one exemplary embodiment of the present disclosure. At step S122, the weighting values of the first regions R₁₁ through R₁₅, R₂₁, R₂₅, R₃₁, R₃₅, R₄₁, R₄₅, R₅₁, and R₅₅ in the image are respectively W₁₁ through W₁₅, W₂₁, W₂₅, W₃₁, W₃₅, W₄₁, W₄₅, W₅₁ and W₅₅. The average luminance values of the first regions R₁₁ through R₁₅, R₂₁, R₂₅, R₃₁, R₃₅, R₄₁, R₄₅, R₅₁, and R₅₅ in the image are respectively A₁₁ through A₁₅, A₂₁, A₂₅, A₃₁, A₃₅, A₄₁, A₄₅, A₅₁ and A₅₅, and thus the light-part weighted average value is (W₁₁·A₁₁+W₁₂·A₁₂+W₁₅·A₁₅+W₂₁·A₂₁+W₂₅·A₂₅ . . . +W₅₅·A₅₅)/13. By a similar manner, the weighting values of the first regions R₂₂ through R₂₄, R₃₂ through R₃₄, R₄₂ through R₄₄, and R₅₂˜R₅₄ are respectively W₂₂ through W₂₄, W₃₂ through W₃₄, W₄₂ through W₄₄, and W₅₂ through W₅₄. The average luminance values of the first regions R₂₂ through R₂₄, R₃₂ through R₃₄, R₄₂ through R₄₄, and R₅₂˜R₅₄ are respectively A₂₂ through A₂₄, A₃₂ through A₃₄, A₄₂ through A₄₄, and A₅₂ through A₅₄, and thus the dark-part weighted average value is (W₂₂·A₂₂+W₂₃·A₂₃+W₂₄·A₂₄+ . . . W₅₄·A₅₄)/12. Then, the difference value of the dark-part weighted average value and light-part weighted average value is calculated, and the second enhancing value is adjusted according to the difference value. By performing the central luminance weighting process, the image which has the light foreground and the dark background within the scene has the positive difference value (i.e. subtract the light-part weighted average value from the dark-part weighted average value), and thus the second enhancing value should be adjusted downward much, so as to avoid strongly adjusting the image without the high contrast grounds.

Still referring to FIG. 1, next, at step S13, the wide dynamic range imaging method selectively performs the dynamic wide range gain adjusting process, the exposure gain adjusting process, or the Gamma gain adjusting process on each of the pixels of the image according to the third enhancing value. Specifically, the third enhancing value is used to determine if the pixels which have luminance values less than the specific threshold value should be adjusted. According to at least one of the selected scene mode, the hardware specification, and the third enhancing value, the wide dynamic range gain adjusting process is performed on the pixels which have luminance values within a first luminance range, the exposure gain adjusting process is performed on the pixels which have luminance values within a second luminance range, and the Gamma gain adjusting process is performed on the pixels which have luminance values within a third luminance range.

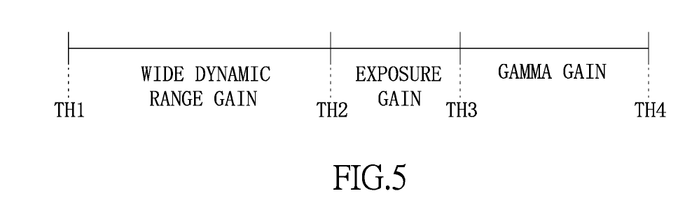

Referring to FIG. 5 and FIG. 1 simultaneously, FIG. 5 is a schematic diagram showing a wide dynamic range gain adjusting process, an exposure gain adjusting process, or a gamma gain adjusting process selectively performed on each pixel of the image according to one exemplary embodiment of the present disclosure. If the wide dynamic range gain adjusting process is performed on all of the pixels associated with the image, the image may have color distortion and edge effect (the effect which the edge appears discontinuous). Thus, at step S13, the wide dynamic range gain adjusting process is performed only on the pixels which have the luminance values within the first luminance range between the two threshold values TH1 and TH2, the exposure gain adjusting process is performed only on the pixels which have the luminance values within the second luminance range between the two threshold values TH2 and TH3, and the Gamma gain adjusting process is performed only on the pixels which have the luminance values within the third luminance range between the two threshold values TH3 and TH4.

It is noted that, the threshold value TH1 is determined by the third enhancing value, and the other threshold values TH2 through TH4 can be determined according to at least one of the selected scene mode, the hardware specification, and the third enhancing value. For example, the third enhancing value can be a percentage, such as 90%, and the threshold values TH1 through TH4 are respectively 90%, 30%, 20%, and 10% of the maximum luminance value. The wide dynamic range gain adjusting process can be the pixel adjusting manner of the conventional wide dynamic range imaging method, the exposure gain adjusting process can be the conventional exposure time adjusting manner of the pixels, and the Gamma gain adjusting process can be the conventional pixel adjusting manner by using the Gamma mapping curve, and therefore the details of them are omitted herein.

In short, the exemplary embodiment of the present disclosure provides a wide dynamic range imaging method, and the wide dynamic range imaging method can increase fineness of the whole image and simultaneously make details in the dark region and the light region be viewed more apparently. Furthermore, the wide dynamic range imaging method can further solve the color distortion and edge effect of the adjusted image. Additionally, the computation complexity of the wide dynamic range imaging method is not large, the execution speed of it is quick, and the hardware complexity is not large, such that it can be implemented in the electronic apparatus easily, without changing the design of the light sensing component.

The above-mentioned descriptions represent merely the exemplary embodiment of the present disclosure, without any intention to limit the scope of the present disclosure thereto. Various equivalent changes, alterations or modifications based on the claims of present disclosure are all consequently viewed as being embraced by the scope of the present disclosure.

What is claimed is:

1. A wide dynamic range imaging method, comprising:
obtaining a first enhancing value according to a first difference value between a light-part average luminance value and a dark-part average luminance value of an image;
adjusting the first enhancing value to generate a second enhancing value according to the dark-part average luminance value and a dark-part pixel number;
calculating a light-part weighted average value in first regions of the image and a dark-part weighted average value in second regions of the image, calculating a second difference value between the dark-part weighted average value and the light-part weighted average value, and adjusting the second enhancing value to generate a third enhancing value according to the second difference value; and
using the third enhancing value to selectively adjust pixels of the image.

2. The wide dynamic range imaging method as cited in claim 1, wherein a histogram of the image is obtained, the dark-part average luminance value is calculated according to luminance values of the pixels lower than a threshold value, and the light-part average luminance value is calculated according to luminance values of the pixels larger than or equal to the threshold value.

3. The wide dynamic range imaging method as cited in claim 1, wherein the first regions are associated with a background of the image, and the second regions are associated with a foreground of the image.

4. The wide dynamic range imaging method as cited in claim 3, wherein the light-part weighted average value is calculated according to weighting values and average luminance values of the first regions, and the dark-part weighted average value is calculated according to weighting values and average luminance values of the second regions.

5. The wide dynamic range imaging method as cited in claim 4, wherein a division of the first regions and the second regions associated with the image and the weighting values are determined according to a scene mode.

6. The wide dynamic range imaging method as cited in claim 1, wherein according to the third enhancing value, a wide dynamic range gain adjusting process, an exposure gain adjusting process, or a gamma gain adjusting process is selectively performed on each of the pixels, and then an adjusted image is output.

7. The wide dynamic range imaging method as cited in claim 6, wherein a first threshold value is determined according to the third enhancing value, and the wide dynamic range gain adjusting process, the exposure gain adjusting process, or the gamma gain adjusting process is selectively performed on each of the pixels which have luminance values lower than the first threshold value.

8. The wide dynamic range imaging method as cited in claim 7, wherein the wide dynamic range gain adjusting process is performed on each of the pixels which have luminance values within a luminance range between the first threshold value and a second threshold value, the exposure gain adjusting process is performed on each of the pixels which have luminance values within a luminance range between the second threshold value and a third threshold value, and the gamma gain adjusting process is performed on each of the pixels which have luminance values within a luminance range between the third threshold value and a fourth threshold value.

9. The wide dynamic range imaging method as cited in claim 8, wherein the second through the fourth threshold values are determined according to at least one of the third enhancing value, a selected scene mode, and a hardware specification.

10. The wide dynamic range imaging method as cited in claim 1, wherein the larger the first difference value is, the larger the first enhancing value is; the less the dark-part average luminance value is, or the larger the dark-part pixel number is, the larger the second enhancing value is; when the second difference value is positive, the second enhancing value is decreased, and then the third enhancing value is generated accordingly.
